(19) United States
(12) Patent Application Publication
(10) Pub. No.: US 2008/0082616 A1
(43) Pub. Date: Apr. 3, 2008

(54) INFORMATION PROCESSING APPARATUS AND MAIL RECEIVING METHOD

(75) Inventors: Toshikazu Morisawa, Tokorozawa-shi (JP); Toshitaka Sanada, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 11/864,429

(22) Filed: Sep. 28, 2007

(30) Foreign Application Priority Data
Sep. 29, 2006 (JP) 2006-268259

(51) Int. Cl. G06F 15/16

(52) U.S. Cl. 709/206

(57) ABSTRACT

According to one embodiment, an information processing apparatus comprising a forming section which forms a copy of the received data stored in a disk storage medium to a nonvolatile memory in response to occurrence of a sleep event, a setting section which sets a timing at which the system is set to the working state when the system state is changed to the sleeping state, a recovering section which recovers the system to the working state at the set timing, a receiving section which receives data of electronic mail after recovery to the working state, an adding section which adds the received data of electronic mail to the received data stored in the nonvolatile memory, and a synchronizing section which synchronizes the received data stored in the disk storage medium with the received data stored in the nonvolatile memory.

### CROSS-REFERENCE TO RELATED APPLICATIONS

This application is based upon and claims the benefit of priority from Japanese Patent Application No. 2006-268259, filed Sep. 29, 2006, the entire contents of which are incorporated herein by reference.

### BACKGROUND

1. Field

One embodiment of the invention relates to an information processing apparatus having a function of receiving electronic mail from a server, and a mail receiving method.

2. Description of the Related Art

In the present business scene, electronic mail is indispensable. Therefore, it is required to periodically confirm newly received mail.

In order to satisfy the above requirement, a portable communication apparatus which powers up at a preset time, receives/transmits electronic mail, and then powers down when all of the tasks are terminated is disclosed in Jpn. Pat. Appln. KOKAI Publication No. 2002-164839.

In the case of a personal computer, data used to start an operating system, mailer or the like is stored in a hard disk drive, and it is necessary to spin up the hard disk drive to read out data from the hard disk drive in order to periodically confirm newly received mail. This spin-up operation consumes much power. For notebook-size personal computers, which are usually driven by batteries, the battery may run down sooner if mail needs to be confirmed regularly. Thus, it is desirable to suppress the power consumption at the time mail is confirmed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the outer appearance of an information processing apparatus according to a first embodiment of this invention;

FIG. 2 is an exemplary block diagram showing the system configuration of the information processing apparatus according to the first embodiment;

FIG. 3 is an exemplary view showing a setting screen displayed according to a utility program;

FIG. 4 is an exemplary flowchart for illustrating the procedure of an automatic mail receiving operation and received data synchronizing process in the first embodiment;

FIG. 5 is an exemplary diagram showing the storage contents of a hard disk drive according to a second embodiment of this invention; and

FIG. 6 is an exemplary flowchart for illustrating the procedure of an automatic mail receiving operation and received data synchronizing process in the second embodiment.

### DETAILED DESCRIPTION

Various embodiments according to the invention will be described hereinafter with reference to the accompanying drawings. In general, according to one embodiment of the invention, an information processing apparatus comprises a disk storage medium in which received data of electronic mails is stored, a nonvolatile memory, a main memory, a radio communicating section which makes wireless communication with a server which stores electronic mails sent to an address of a user, a forming section which forms a copy of the received data stored in the disk storage medium to the nonvolatile memory in response to occurrence of a sleep event instructing that a system state of the information processing apparatus is changed from an working state to a sleeping state, a changing section which changes the system state to the sleeping state in response to occurrence of the sleep event after system information to restore a system operation environment of the information processing apparatus set immediately before the system state is changed to the sleeping state is stored to one of the nonvolatile memory and main memory, a setting section which sets a timing at which the system is set to the working state when the system state is changed to the sleeping state, recovering section which recovers the system to the working state by using the system information stored in at least one of the nonvolatile memory and main memory at the set timing, a receiving section which receives data of electronic mail by making communication with the server by use of the radio communicating section after recovery to the working state, an adding section which adds the received data of electronic mail to the received data stored in the nonvolatile memory when the data of electronic mail is received, and a synchronizing section which synchronizes the received data stored in the disk storage medium with the received data stored in the nonvolatile memory when the system is set to the working state at a timing other than the set timing.

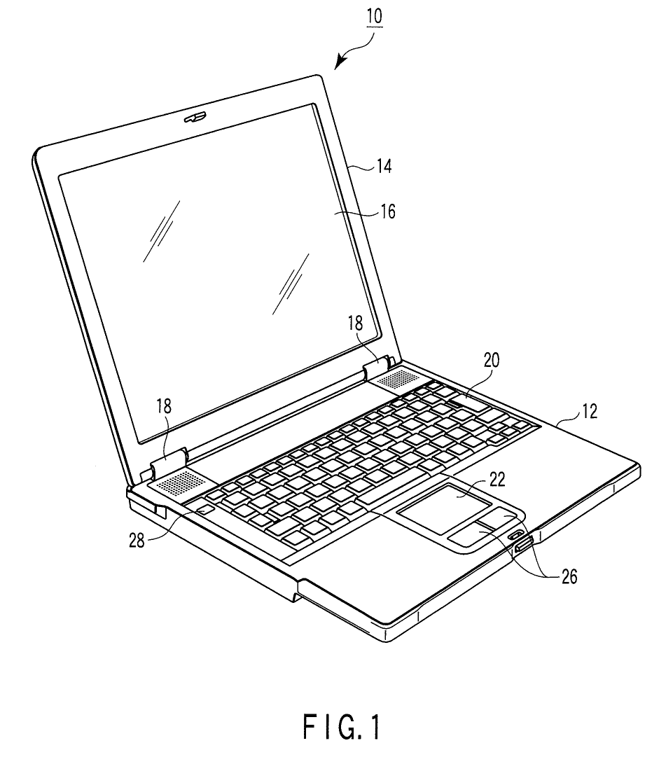

FIG. 1 is a view showing one example of the configuration of a notebook-size personal computer as an information processing apparatus according to one embodiment of this invention.

A personal computer 10 has a computer main body 12 and display unit 14. An LCD (Liquid Crystal Display) 16, which is a display section, is incorporated in the display unit 14.

The display unit 14 is mounted by use of hinges (supporting portions) 18 provided on the end portions on the rear side of the computer main body 12 so as to freely make a swing between the open position, in which it covers the upper surface of the computer main body 12, and the closed position, in which the upper surface of the computer main body 12 is exposed.

The computer main body 12 is formed of a thin box-type casing and has a keyboard 20 provided on the upper central surface portion of the casing. A palm rest is formed on the upper surface portion of the casing on the front side of the computer main body 12. A touch pad 22 and touch pad control buttons 26 used as operating means are provided on substantially the central portion of the palm rest. A power button 28 used to turn ON/OFF the power supply of the computer main body 12 is arranged on the upper surface of the casing on the rear side of the computer main body 12.

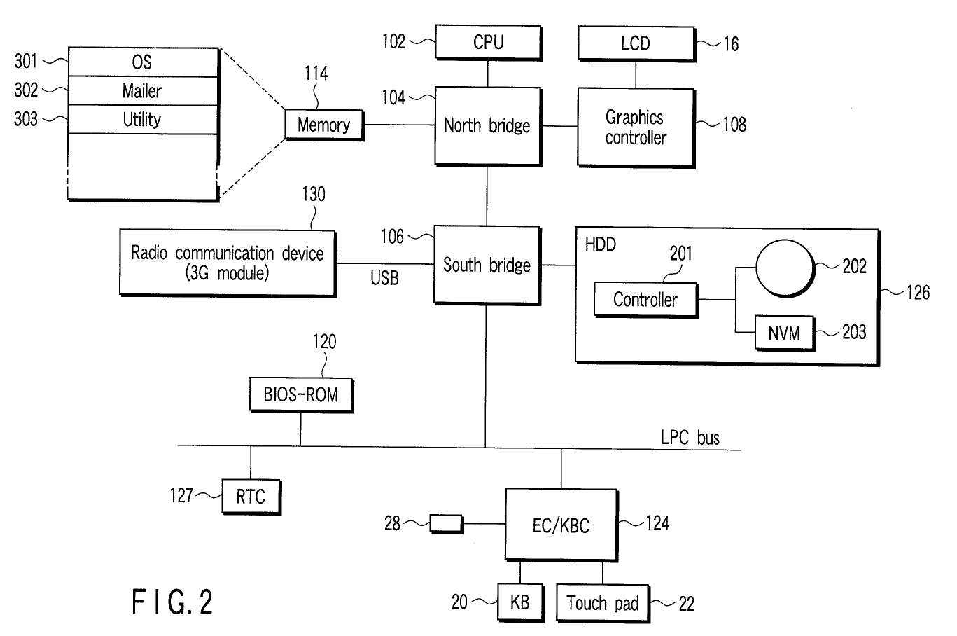

Next, one example of the system configuration of the computer is explained with reference to FIG. 2.

As shown in FIG. 2, the computer includes a CPU 102, north bridge 104, main memory 114, graphics controller 108, south bridge 106, BIOS-ROM 120, hard disk drive (HDD) 126, embedded controller/keyboard controller IC (EC/KBC) 124, real time clock (RTC) 127, radio communication device 130 and the like.

The HDD 126 includes a controller 201, magnetic disk 202 and non-volatile memory (NVM) 203. For example, the non-volatile memory 203 is configured by a NAND flash EEPROM. The controller 201 selectively accesses the magnetic disk 202 and non-volatile memory 203.

With the HDD 126, the information writing and reading speeds are enhanced and the number of driving operations of the hard disk, that is, the number of information writing and reading operations with respect to the hard disk, is reduced so as to reduce the power consumption of the battery cell by using the non-volatile memory 203 as a cache memory for the magnetic disk 202.

The CPU 102 is a processor provided to control the operation of the computer and executes various application programs containing an operating system (OS) 301, mailer 302 and utility 303 which are loaded from the hard disk drive (HDD) 126 to the main memory 114. The mailer 302 makes communication with a server which stores electronic mail addressed to the user by use of a radio communication device 130 to receive or transmit the mail. Further, the utility 303 is a module which permits the mailer 302 to confirm received mail when the system of the computer is set in the sleeping state.

The CPU 102 loads a system BIOS (Basic Input Output System) stored in the BIOS-ROM 120 to the main memory 114 and then executes the same. The system BIOS is a program to perform the hardware control operation.

The north bridge 104 is a bridge device which connects the south bridge 106 to the local bus of the CPU 102. Further, the north bridge 104 also has a function of making communication with the graphics controller 108 via an AGP (Accelerated Graphics Port) bus or the like.

The graphics controller 108 is a display controller which controls the LCD 16 used as a display monitor of the computer. The graphics controller 108 has a video memory (VRAM) and generates a video signal which forms a display image to be displayed on the LCD 16 based on display data drawn in the video memory according to an OS/application program. The video signal generated from the graphics controller 108 is output to a line.

The south bridge 106 is connected to a PCI (Peripheral Component Interconnect) bus and LPC (Low Pin Count) bus. The south bridge 106 contains an IDE (Integrated Drive Electronics) controller, which controls the HDD 126, and a USB (Universal Serial Bus) host controller, which controls a USB device. The south bridge 106 is connected to the radio communication device 130 via a serial bus such as a USB.

The embedded controller/keyboard controller IC 124 controls the touch pad 22 as input means and the touch pad control buttons 26. The embedded controller/keyboard controller IC 124 is a one-chip microcomputer which monitors and controls various devices (peripheral devices, sensors, power supply circuits and the like) irrespective of the system condition of the computer 10.

The radio communication device 130 makes radio communication with a base station according to the radio communication standard, such as 3G Wireless WAN. “3G Wireless WAN” is a wide-band radio network, such as a portable telephone network.

The function of the mailer 302 to cause the server to confirm newly received mail when the system of the present apparatus is set in a sleeping state is explained below.

The function of confirming newly received mail in the sleeping state can be turned ON/OFF according to the setting function of the utility 303. Further, when the above function is effective, it is possible to set the time interval for confirmation of newly received mail.

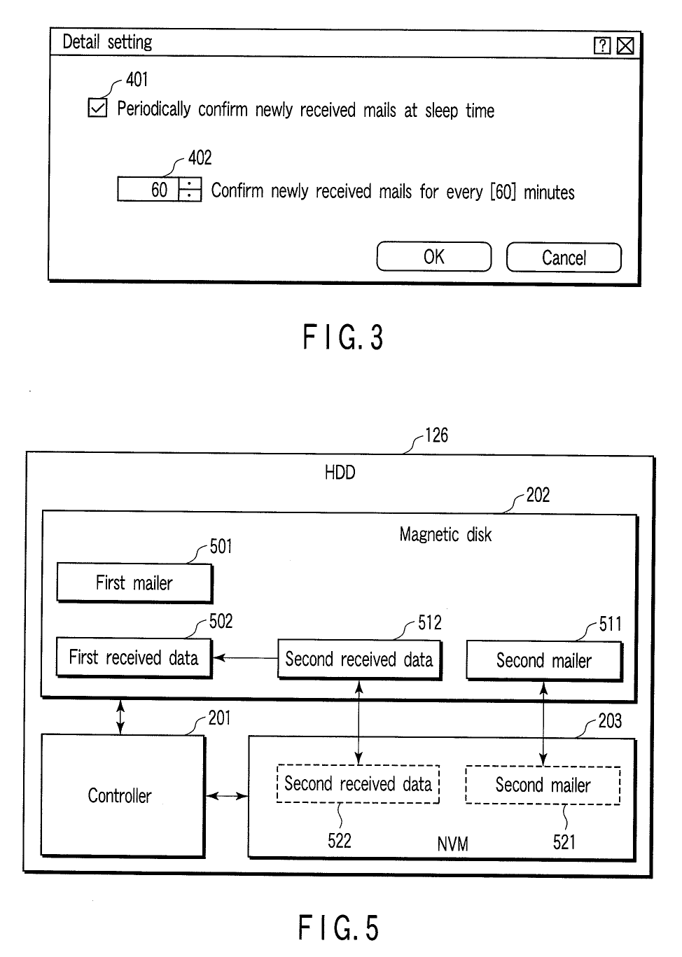

A setting screen displayed to set whether or not newly received mail is confirmed at the sleep time is shown in FIG. 3. Inserting a check mark in a check box 401 shown in FIG. 3 makes it possible to confirm the presence or absence of newly received mail at the suspend state. Further, the timing for confirmation of newly received mail can be changed by changing the numeral value in a box 402.

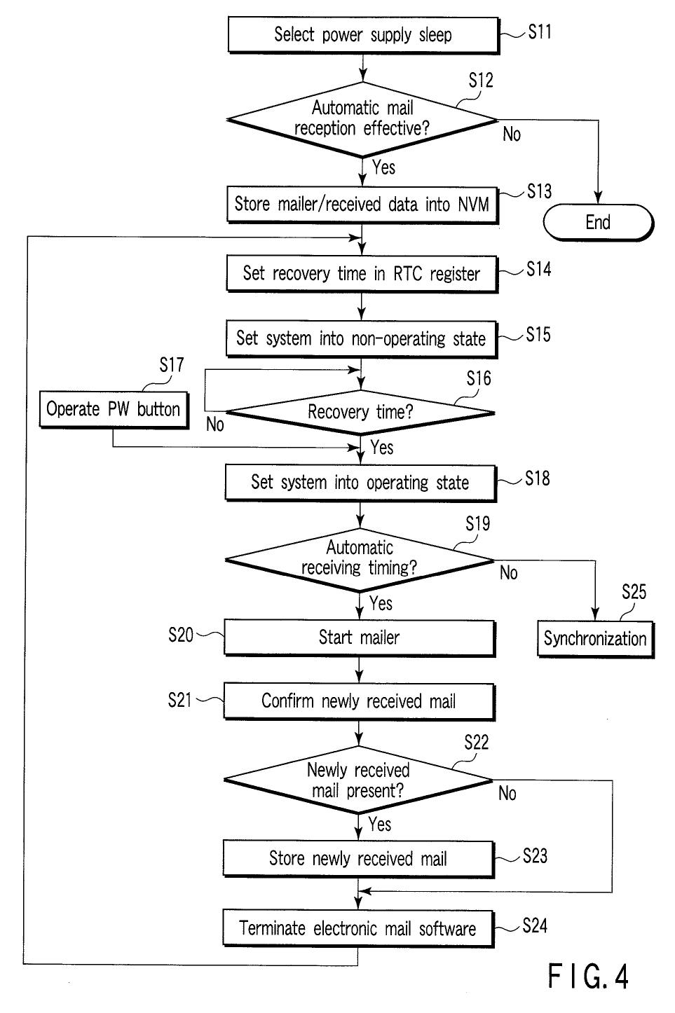

Next, regarding the efficacy of the function of checking the presence or absence of a newly received mail, a process procedure is explained with reference to the flowchart of FIG. 4.

A sleep event occurs (step S11) when the user selects a certain state in the sleeping (suspend or hibernation) state. In the suspend state, devices other than the memory 114 are set in the power-saving mode while data now under operation is kept stored in the memory 114. In the hibernation state, data now under operation is written as a hibernation file to the HDD 126 and the device is set to the power-saving mode. In the case of the present apparatus, the hibernation file is written to the non-volatile memory 203 of the HDD 126 to shorten the time required for recovery.

When detecting that the sleep event has occurred, the utility 303 determines whether the automatic mail receiving function is effective or not (step S12). When it is determined that the automatic newly received mail receiving function is not effective (“NO” in the step S12), the utility 303 does not perform any process, and terminates the process.

When it is determined that the automatic newly received mail receiving function is effective (“YES” in the step S12), received data and a file necessary for start/execution of the mailer 302 stored in the magnetic disk 202 are stored to the non-volatile memory 203 (step S13). This process is explained below. The utility 303 issues an instruction to the operating system (OS) 301 to store received data and a file necessary for start/execution of the mailer 302 stored in the magnetic disk 202 to the non-volatile memory 203. In this case, if the mailer 302 is being executed, the above process is performed after the mailer 302 is terminated. The operating system (OS) 301 specifies a logical block address (LBA) of the received data and the file necessary for start/execution of the mailer 302 stored in the magnetic disk 202 and issues a command to be stored in the non-volatile memory 203 to the HDD 126. The controller 201 of the HDD 126 stores data stored in the magnetic disk 202 to the non-volatile memory 203 based on the command.

Then, the utility 303 sets the time (year, month, date, minute, second) corresponding to the time at which the presence or absence of a next newly received mail is checked based on the next setting to the real time clock (RTC) 127 (step S14). The set time is also stored in the non-volatile memory 203 of the HDD 126.

After this, the operating system (OS) 301 transmits a command to the EC/KBC 124 and sets the system of the computer 10 to the sleeping state (step S15) after a process corresponding to the item selected by the user is performed. When the state is changed to the suspend state, the operating system (OS) 301 stores system information used to restore the system operation environment of the information processing apparatus attained immediately before the state is changed to the sleeping state to the memory 114. When the state is changed to the hibernation state, the operating system (OS) 301 stores system information used to restore the system operation environment of the information processing apparatus attained immediately before the state is changed to the sleeping state to the non-volatile memory 203. In this case, the system information can be stored to both of the memory 114 and non-volatile memory 203.

The real time clock 127 transmits a power-ON event to the EC/KBC 124 when the present time has reached the alarm time set in the step S14 (“YES” in the step S16). The EC/KBC 124 recovers the computer 10 in cooperation with the power supply circuit (step S18) when occurrence of the power-ON event is detected.

When the EC/KBC 124 detects that the power button is operated, it recovers the computer 10 in cooperation with the power supply circuit (step S18) even if the alarm time is not reached.

After recovery, the utility 303 refers to the set newly received mail confirmation timing to determine whether the timing is an automatic mail reception timing or not (step S19). In this example, whether the timing is the automatic mail reception timing or not is determined by comparing the time set in the RTC 127 stored in the non-volatile memory 203 with the recovery time. For example, if the difference between the recovery time and the time set in the RTC 127 is less than two minutes, it is determined that the timing is the automatic mail reception timing.

If it is determined that the timing is the automatic mail reception timing (“YES” in the step S19), the utility 303 starts the mailer 302 (step S20). Since the file necessary for start/execution of the mailer 302 is stored in the non-volatile memory 203 of the HDD 126, the necessary file can be loaded from the non-volatile memory 203 to the memory 104 without spinning up the magnetic disk 202. The mailer 302 automatically causes the server to perform the newly received mail confirmation process immediately after it is started.

After starting, the mailer 302 inquires of the server as to whether a newly received mail is present or not by making communication with the server by use of the radio communication device 130 (step S21). If the newly received mail is present (“YES” in the step S22), the mailer 302 performs a process of receiving the newly received mail from the server and storing the received mail data in addition to received data in the HDD 126 (step S23). At the additional storage time, the received data is stored in the non-volatile memory 203 and magnetic disk 202. Since the received data is stored in the non-volatile memory 203, the controller 201 stores the received mail in addition to the received data in the non-volatile memory 203.

After the storage process of the step S23 is terminated or if no newly received mail is present (“NO” in the step S22), the utility 303 terminates the mailer 302 (step S24). Then, the process returns to the step S14.

If it is determined that the timing is not the automatic mail reception timing (“NO” in the step S19), that is, when the power button is operated to recover the system, a process for synchronizing the non-volatile memory 203 with the magnetic disk 202 is performed (step S25). The process is explained below. The utility 303 instructs the operating system (OS) 301 to synchronize data stored in the cache area of the non-volatile memory 203 with the HDD 126 stored in the magnetic disk 202. The operating system (OS) 301 transmits a flash command to the HDD 126 in order to attain synchronization. The controller 201 of the HDD 126 synchronizes data in the cache area with data in the magnetic disk 202. By performing the above process, received data containing data of a newly received mail is stored to the magnetic disk 202 when the newly received mail is obtained.

According to the process described above, even when the system of the computer 10 is set in the sleeping state, newly received mail can be periodically confirmed. Further, since the magnetic disk is not rotated at the recovery time to confirm the presence of newly received mail, the power consumption can be suppressed.

In the above embodiment, the magnetic disk 202 and non-volatile memory 203 are housed in the HDD 126, and the controller 201 synchronizes data in the magnetic disk 202 with data in the non-volatile memory 203 by causing the operating system (OS) 301 to transmit a command to the HDD 126.

However, it is not always necessary to provide the non-volatile memory 203 in the HDD 126. For example, received data in the HDD 126 can also be set in the newest state if the utility 303 automatically synchronizes data in the magnetic disk 202 with data in the non-volatile memory 203.

### SECOND EMBODIMENT

When the capacity of mail data is large, the data cannot be stored in the non-volatile memory in some cases. Next, an avoidance method used when the capacity of received data of a mailer normally used is explained below.

The storage contents of an HDD of the present apparatus is shown in FIG. 5. As shown in FIG. 5, a first mailer execution file 501 used to execute a first mailer, first received data 502, a second mailer execution file 511 used to execute a second mailer and second received data 512 are stored in a magnetic disk 202 of an HDD 126. The first mailer is a mailer normally used by the user. The first received data 502 is data of a mail which the first mailer has received from the server. The second mailer is not a mailer which is normally used by the user. The second received data 512 is data of a mail which the second mailer has received from the server. However, generally, a state in which data of the received mail is not contained in the second received data is set. Further, the second mailer is not required to have a mail transmission function, and is only required to have a mail receiving function and storage function.

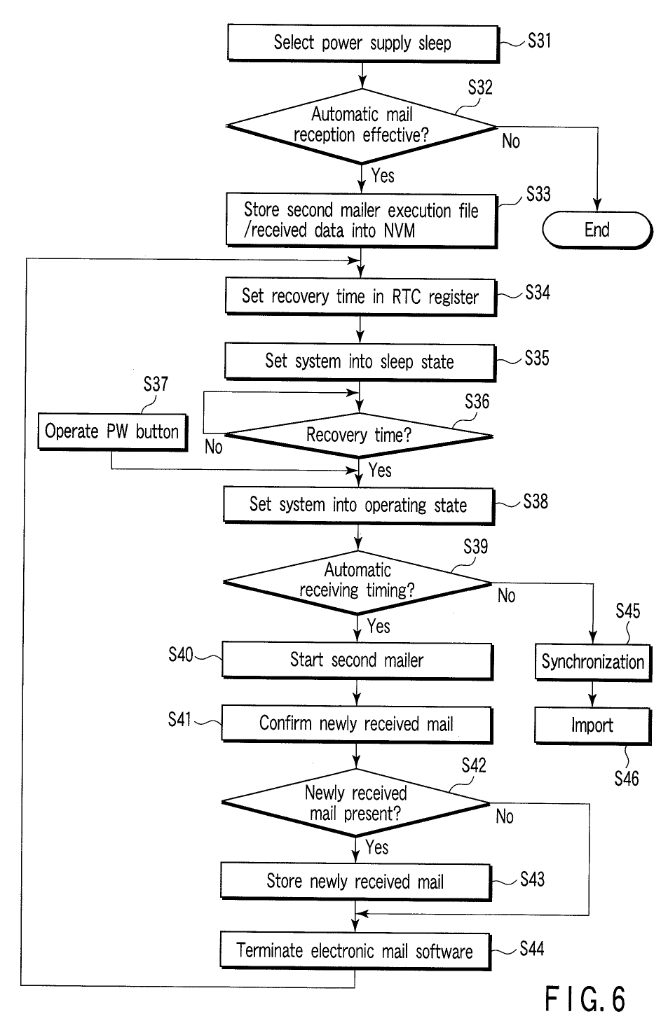

Next, the procedure of an automatic mail receiving operation and received data synchronizing process of the present embodiment is explained with reference to the flowchart of FIG. 6.

When the user selects one of the sleeping states (suspend and hibernation states), a sleep event occurs (step S31). When detecting occurrence of the sleep event, a utility 303 determines whether the automatic mail receiving function is effective or not (step S32). When it is determined that the automatic newly received mail receiving function is not effective (“NO” in the step S32), the utility 303 does not perform any process and terminates the process.

When it is determined that the automatic newly received mail receiving function is effective (“YES” in the step S32), the second received data 512 and the second mailer execution file 511 necessary for start/execution of the second mailer stored in the magnetic disk 202 are stored to the non-volatile memory 203 (step S33).

This process is explained below. The utility 303 issues an instruction to the operating system to store the second received data 512 and second mailer execution file 511 stored in the magnetic disk 202 to the non-volatile memory 203. In this case, if the first mailer is being executed, the above process is performed after the first mailer is terminated. The operating system specifies a logical block address (LBA) of the second mailer execution file 511 and second received data 512 stored in the magnetic disk 202 and issues a command to be stored in the non-volatile memory 203 to the HDD 126. The controller 201 of the HDD 126 stores data stored in the magnetic disk to the non-volatile memory 203 based on the command.

Then, the utility 303 sets the time (year, month, date, minute, second) corresponding to the time at which the presence or absence of a next newly received mail is checked based on the setting to a real time clock 127 (step S34). After this, the operating system 301 transmits a command to an EC/KBC 124 and sets the system of the computer 10 to the sleeping state (step S35) after a process corresponding to the item selected by the user in the step S31 is performed. When the state is changed to the suspend state, the operating system (OS) 301 stores system information used to restore the system operation environment of the information processing apparatus set immediately before the state is changed to the sleeping state to the memory 114. When the state is changed to the hibernation state, the operating system (OS) 301 stores system information used to restore the system operation environment of the information processing apparatus set immediately before the state is changed to the sleeping state to the non-volatile memory 203. In this case, the system information can be stored to both of the memory 114 and non-volatile memory 203.

The real time clock 127 transmits a power-ON event to the EC/KBC 124 when the present time has reached the set alarm time (“YES” in the step S36). The EC/KBC 124 recovers the computer 10 to the working state in cooperation with the power supply circuit (step S38) when occurrence of the power-ON event is detected.

When the EC/KBC 124 detects the operation of the power button (step S37), it recovers the computer 10 in cooperation with the power supply circuit (step S38) even if the alarm time is not reached.

After recovery, the utility 303 refers to the set newly received confirmation timing to determine whether the timing is the automatic mail reception timing or not (step S39).

If it is determined that the timing is the automatic mail reception timing (“YES” in the step S39), the utility starts the second mailer (step S40). Since a second mailer execution file 521 necessary for start/execution of the second mailer is stored in the non-volatile memory 203 of the HDD 126, the necessary file can be loaded from the non-volatile memory 203 to the memory 114 without spinning up the magnetic disk 202.

After starting, the second mailer inquires of the server as to whether a newly received mail is present or not by making communication with the server by use of a radio communication device 130 (step S41). If the newly received mail is present (“YES” in the step S42), the second mailer performs a process of receiving the newly received mail from the server and storing the received mail in addition to second received data 522 in the HDD 126 (step S43). At the additional storage time, the second received data 522 is stored in the non-volatile memory 203. Since the second received data 522 is stored in the non-volatile memory, the controller 201 stores the received mail in addition to the second received data 522 in the non-volatile memory 203.

After the storage process of the step S43 is terminated or if no newly received mail is present (“NO” in the step S42), the utility terminates the second mailer (step S44). Then, the process returns to the step S34.

If it is determined that the timing is not the automatic mail reception timing (“NO” in the step S39), that is, when the power button is operated to recover the system, a process for synchronizing the non-volatile memory with the magnetic disk is performed (step S45). The process is explained below. The utility instructs the operating system 301 to synchronize the second received data 522 stored in the non-volatile memory 203 of the HDD 126 with the second received data 512 stored in the magnetic disk. The operating system 301 transmits a flash command to the HDD 126 in order to attain synchronization. The controller 201 of the HDD 126 synchronizes the second received data 522 in the non-volatile memory 203 with the second received data 512 in the magnetic disk 202. By performing the above process, received data containing data of a newly received mail is stored to the magnetic disk when the newly received mail is obtained.

After this, the utility imports the received data stored in the magnetic disk to the first received data 502 which the user normally uses (step S46). In this process, the first received data 502 of the first mailer normally used is set to the newest state.

Next, the utility deletes data of the received mail in the second received data 512 of the second mailer. A state in which the capacity of received data is always small is set when the second received data 512 is transferred to the non-volatile memory by deleting the data of the received mail from the second received data 512. Therefore, the volume of the mail of the second received data 512 is prevented from becoming too large to be stored in the non-volatile memory.

In the above embodiment, the magnetic disk 202 and the non-volatile memory 203 are provided in the hard disk drive, but they are not necessarily provided in one drive.

Further, a device which sets the time for starting the system and transmits a power-ON event to the EC/KBC is not limited to the RTC. For example, an execution timing measurement timer may be provided in the EC/KBC, or a power-ON event may be transmitted from a device other than the RTC.

Further, if the mailer has a function of confirming a newly received mail by transmitting a command to the mailer, it is not necessary to temporarily terminate the mailer when the state is changed to the sleeping state. In this case, the newly received mail may be confirmed by transmitting a command from the utility.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a disk storage medium configured to store electronic mail data;
a nonvolatile memory;
a main memory;
a radio communicating section configured to communicate wirelessly with a server that stores electronic mail;
a forming section configured to copy the electronic mail data from the disk storage medium to the nonvolatile memory in response to an instruction to change a system state of the information processing apparatus from a working state to a sleeping state;
a changing section configured to change the system state to the sleeping state in response to the instruction to change after storing system information for recovering the information processing apparatus to the working state in at least one of the nonvolatile memory and main memory;
a setting section configured to, when the system state is changed to the sleeping state, set a time at which the system is to be recovered to the working state;
a recovering section configured to recover the system to the working state using the system information stored in at least one of the nonvolatile memory and main memory at the set time;
a receiving section configured to receive additional electronic mail data from the server by use of the radio communicating section after recovery to the working state;
an adding section configured to combine the additional data with the electronic mail data stored in the nonvolatile memory when the additional data is received; and
a synchronizing section configured to synchronize the electronic mail data stored in the disk storage medium with the combined electronic mail data stored in the nonvolatile memory when the system state is set to the working state at a time other than the set time.

2. The information processing apparatus according to claim 1, wherein the receiving section is configured to communicate with the server by use of the radio communicating section, and wherein the receiving section further comprises:
a judging section configured to determine, in response to the instruction to change, whether the receiving section is operating;
a terminating section configured to terminate, in response to the instruction to change, the operation of the receiving section when it is determined that the receiving section is operating;
a storing section configured to store, to the nonvolatile memory, operation data used to operate the receiving section, the storing section configured to store such operation data in response to the instruction to change; and
an activating section configured to activate the operation of the receiving section by use of the operation data stored in the nonvolatile memory after recovery to the working state.

3. The information processing apparatus according to claim 1, further comprising:
a second mail receiving section configured to receive second electronic mail data and configured to store the second electronic mail data in the disk storage medium; and
an importing section configured to combine the second electronic mail data with the electronic mail data in the disk storage medium.

4. The information processing apparatus according to claim 3, further comprising
a judging section configured to determine, in response to the instruction to change, whether the second mail receiving section is operating; and
a terminating section configured to terminate, in response to the instruction to change, the operation of the second mail receiving section when it is determined that the second mail receiving section is operating.

5. The information processing apparatus according to claim 3, wherein the second mail receiving section is configured to receive electronic mail data and not to transmit electronic mail data.

6. The information processing apparatus according to claim 1, wherein the disk storage medium and nonvolatile memory are provided in a one drive apparatus.

7. An electronic mail receiving method for an information processing apparatus comprising a main memory, a disk storage medium that stores electronic mail data received by a receiving section, and a nonvolatile memory, the method comprising:
copying the electronic mail data stored in the disk storage medium to the nonvolatile memory in response to an instruction to change a system state of the information processing apparatus from a working state to a sleeping state;
storing system information for recovering a system operation environment of the information processing apparatus in at least one of the nonvolatile memory or the main memory;
changing the system state to the sleeping state in response to the instruction to change after system information is stored;
setting a predetermined time when the system state is changed to the sleeping state, the predetermined time corresponding to a time at which the system is to be recovered to the working state;
recovering the system to the working state at the predetermined time using the system information;
receiving additional electronic mail data after recovery to the working state from a server that stores electronic mail;
combining the additional electronic mail data with the electronic mail data stored in the nonvolatile memory when the additional electronic mail data is received; and
synchronizing the electronic mail data stored in the disk storage medium with the combined electronic mail data stored in the nonvolatile memory when the system is recovered to the working state at a time other than the predetermined time.

8. The mail receiving method according to claim 7, further comprising:
determining, in response to the instruction to change, whether the receiving section is operating;
terminating the operation of the receiving section when it is determined that the receiving section is operating;
storing, to the nonvolatile memory, operation data used to operate the receiving section in response to the instruction to change; and
starting the receiving section using the operation data stored in the nonvolatile memory after recovery to the working state.

9. The mail receiving method according to claim 7, wherein the disk storage medium stores second electronic mail data received by a second receiving section, and the method further comprises combining contents of the second electronic mail data with the electronic mail data in the disk storage medium after synchronization.

10. The mail receiving method according to claim 9, further comprising:
Determining, in response to the instruction to change, whether the second receiving section is operating; and
Terminating, in response to the instruction to change, the second receiving section when it is determined that the second receiving section is operating.

11. The mail receiving method according to claim 9, wherein the second receiving section is configured to receive electronic mail from the server and not to transmit electronic mail to the server.

12. The mail receiving method according to claim 7, wherein the disk storage medium and nonvolatile memory are provided in one drive.
